(19) United States
(12) Patent Application Publication
(10) Pub. No.: US 2014/0006019 A1
(43) Pub. Date: Jan. 2, 2014

(54) APPARATUS FOR AUDIO SIGNAL PROCESSING

(71) Applicants: Erkki Juhani Paajanen, Tampere (FI); Riitta Elina Niemistö, Tampere (FI)

(72) Inventors: Erkki Juhani Paajanen, Tampere (FI); Riitta Elina Niemistö, Tampere (FI)

(73) Assignee: Nokia Corporation, Espoo (FI)

(21) Appl. No.: 14/004,549

(22) PCT Filed: Mar. 18, 2011
(86) PCT No.: PCT/IB11/51150

§ 371 Date: Sep. 11, 2013

(51) Int. Cl. G10L 21/0216

(52) U.S. Cl. CPC G10L 21/0216
USPC 704/233

(57) ABSTRACT

A method for estimating background noise of an audio signal comprises detecting voice activity in one or more frames of the audio signal based on one or more first conditions. The method also comprises estimating a first background noise estimation if voice activity is not detected based on the one or more first conditions. Voice activity in the one or more frames of the audio signal based on one or more second conditions is detected. A second background noise estimation is estimated if voice activity is not detected based on the one or more second conditions. The voice activity is detected in the one or more frames less often based on the one or more first conditions than based on the one or more second conditions.

### FIELD OF THE APPLICATION

The present application relates to a method and apparatus for audio signal processing. In some embodiments the method and apparatus relate to estimating background noise in an audio speech signal.

### BACKGROUND OF THE APPLICATION

In mobile telecommunications the quality of an audio speech signal can be degraded due to the presence of environmental background noise. For example, a noisy audio speech signal can be generated by a speech encoder if background noise and speech are encoded together.

Some noise reduction methods can be applied close to the source of the background noise, such as in a transmitting mobile terminal. Additional noise reduction can also be applied to a downlink audio speech signal path in a receiving mobile terminal to reduce background noise in the audio speech signal if there has not been sufficient noise reduction in the transmitting terminal.

During a conversation between two mobile terminals there may naturally be pauses wherein an audio speech signal can comprise one or more frames of background noise only. The transmitting mobile terminal can apply discontinuous transmission (DTX) processes during the frames comprising only background noise whereby the transmitting mobile terminal can discontinue speech encoding. This can limit the amount of data transmitted over a radio link and save power used by the transmitting mobile terminal during pauses in speech. The transmitting mobile terminal may indicate to the receiving mobile terminal when discontinuous transmission is active so that the receiving mobile terminal can discontinue speech decoding.

However, when maximum noise suppression is applied to frames which only comprise background noise, a user can perceive silence during this period which can be uncomfortable. To address this, a comfort background noise signal can be generated by the receiving mobile terminal to resemble the background noise detected at the transmitting mobile terminal. The receiving mobile terminal can generate the comfort background noise from estimated parameters of the background noise received from the transmitting mobile terminal.

The receiving mobile terminal may need to determine when an audio signal comprises speech for audio signal processing operations, such as background noise reduction (NR), automatic volume control (AVC) and dynamic range control (DRC). The receiving mobile terminal can implement voice activity detection (VAD) to determine whether an audio signal comprises speech. The VAD can classify between speech and noise on the basis of characteristics of the audio signal, such as spectral distance to a noise estimate, periodicity of the signal and spectral shape of the audio signal. The VAD and the noise estimation take place in the receiving mobile terminal. In this way the VAD can determine whether a frame comprises a speech or noise and enhance the audio signal in the frame accordingly.

In some cases the receiving mobile terminal can apply VAD associated with speech enhancement without knowledge that the DTX is active. This means that during speech pauses the VAD will use the comfort background noise as a basis for a background noise estimate for e.g. noise reduction of the audio speech signal.

The structural spectrum of the actual environmental background noise captured by transmitting terminal can differ from the comfort background noise. For example, periodic noise components will not be reflected in the comfort background noise signal since the latter is created by generating random noise and shaping its spectrum according to the coarse spectral envelope of the actual environmental background noise. In this way once speech frames are received again the periodic noise components may not be attenuated.

Another problem can occur if the receiving mobile terminal receives an indication that DTX is active or inactive. In some known arrangements, speech enhancement comprises processes which can be stopped having received an indication that DTX is active, i.e., in frames which are known not to contain a speech signal. An example is that background noise estimation is halted. That is when DTX is active, a noise estimate used by the VAD associated with speech enhancement of the receiving mobile terminal remains frozen.

If a pause in speech is long enough, the actual background noise can vary from the background noise estimation used by the VAD. This means that when speech frames are received again after the DTX period, the background noise estimation can be too high or too low and background noise may not be attenuated well. Furthermore, when the VAD uses an old background noise estimate which does not represent the actual background noise, the VAD may not be able to differentiate between frames and incorrectly determine that all the frames contain speech.

Embodiments may address one or more of problems mentioned above.

In accordance with an embodiment there is a method for estimating background noise of an audio signal comprising: detecting voice activity in one or more frames of the audio signal based on one or more first conditions; estimating a first background noise estimation if voice activity is not detected based on the one or more first conditions; detecting voice activity in the one or more frames of the audio signal based on one or more second conditions; and estimating a second background noise estimation if voice activity is not detected based on the one or more second conditions; wherein the voice activity is detected in the one or more frames less often based on the one or more first conditions than based on the one or more second conditions.

The method can comprise updating the second background noise estimation based on the first background noise estimation.

The second background noise estimation may be updated with a combination of the first and second background noise estimates.

The second background noise estimation may be updated with the weighted mean of the first and second background noise estimates.

The second background noise estimation may be updated based on the first background noise estimation after a period of time.

The second background noise estimation may be updated based on the first background noise estimation when the first background noise estimate remains within a range for the period of time.

The second background noise estimate may be based on the bandwise maximum of the first and second background noise estimates.

An output of the voice activity detection based on the one or more second conditions and the second background noise estimation can be used for speech enhancement.

The speech enhancement can be one or more of noise reduction, automatic volume control and dynamic range control.

The first one or more conditions and the second one or more conditions can be associated with characteristics of an audio signal. The characteristics can be one or more of the following: the spectral distance of the audio signal to a background noise estimate, periodicity of the audio signal, a direction of the audio signal and the spectral shape of the audio signal.

Detecting the voice activity in the one or more frames of the audio signal can be based on the one or more second conditions occurs when a discontinuous transmission mode is inactive.

The first background noise estimate can be based on a comfort background noise approximation determined from background noise information received during discontinuous transmission frames.

The method can comprise using the first background noise estimate based on the comfort background noise approximation for estimating the second background noise estimate when discontinuous transmission is inactive.

The first background noise estimate based can be used immediately after discontinuous transmission becomes inactive.

The first background noise estimate can be based on the comfort background noise approximation for a period of time.

The first background noise estimate can be based on the comfort background noise approximation whilst the comfort background noise approximation is the most recent background noise estimate.

In accordance with an embodiment there is a method for estimating background noise of an audio signal comprising: estimating a first background noise estimate based on background noise information received during one or more discontinuous transmission frames; estimating a second background noise estimate of the audio speech signal in one or more frames; updating the second background noise estimate based on the first background noise estimate.

The method can comprise estimating the second background noise estimate and updating the second background noise estimate when a discontinuous transmission mode is inactive.

The method can comprise estimating the first background noise estimate when a discontinuous transmission mode is active.

The first background noise estimate may be based on a comfort background noise approximation based on the received background noise information.

The second background noise estimation can be updated with a combination of the first and second background noise estimates.

The second background noise estimation can be updated with the weighted mean of the first and second background noise estimates.

The second background noise estimation can be updated based on the first background noise estimation after a period of time.

The second background noise estimation can be updated based on the first background noise estimation when the first background noise estimate remains within a range for the period of time.

The second background noise estimate can be updated based on the bandwise maxima of the first and second background noise estimates.

In accordance with an embodiment there is a method for estimating background noise of an audio signal comprising: detecting voice activity in one or more frames of the audio signal based on one or more first conditions; estimating a first background noise estimation if voice activity is not detected based on the one or more first conditions; detecting voice activity in the one or more frames of the audio signal based on one or more second conditions, whereby voice activity is detected in the one or more frames more often based on the one or more second conditions than based on the one or more first conditions; estimating a second background noise estimation based if voice activity is not detected based on the one or more second conditions; updating the second background noise estimate based on the first background noise estimate; wherein the estimating the first background noise estimate comprises estimating the first background noise estimate based on background noise information received during one or more discontinuous transmission frames.

A computer program comprising program code means adapted to perform the method may also be provided.

In accordance with an embodiment there is an apparatus comprising: a first voice activity detection module configured to detect voice activity in one or more frames of the audio signal based on one or more first conditions; a first background noise estimation module configured to estimate a first background noise estimation if voice activity is not detected based on the one or more first conditions; a second voice activity detection module configured to detect voice activity in the one or more frames of the audio signal based on one or more second conditions; and a second background noise estimation module configured to estimate a second background noise estimation if voice activity is not detected based on the one or more second conditions; wherein the voice activity is detected in the one or more frames less often based on the one or more first conditions than based on the one or more second conditions.

The second background noise estimation module can be configured to update the second background noise estimation based on the first background noise estimation.

The second background noise estimation module can be configured to update the second background noise estimation with a combination of the first and second background noise estimates.

A speech enhancement module can be configured to use an output of the voice activity detection based on the one or more second conditions and the second background noise estimation. The speech enhancement module can be configured to perform one or more of noise reduction, automatic volume control and dynamic range control.

The second voice activity detection module can be configured to detect the voice activity in the one or more frames of the audio signal based on the one or more second conditions when a discontinuous transmission mode is inactive.

The first background noise estimation module can be configured to estimate the first background noise estimate based on a comfort background noise approximation determined from background noise information received during discontinuous transmission frames.

The second background noise estimation module can be configured to use the first background noise estimate based on the comfort background noise approximation for estimating the second background noise estimate when discontinuous transmission is inactive.

The second background noise estimation module can be configured to use the first background noise estimate immediately after the discontinuous transmission becomes inactive.

In accordance with an embodiment there is an apparatus comprising: a first background noise estimation module configured to estimate a first background noise estimate based on background noise information received during one or more discontinuous transmission frames; a second background noise estimation module configured to estimate a second background noise estimate of the audio speech signal in one or more frames; and the second background noise estimation module is configured to update the second background noise estimate based on the first background noise estimate.

The second background noise estimation module can be configured to estimate the second background noise estimate and update the second background noise estimate when a discontinuous transmission mode is inactive. The first background noise estimation module is configured to estimate the first background noise estimate when a discontinuous transmission mode is active.

In accordance with an embodiment there is an apparatus comprising: a first voice activity detection module configured to detect voice activity in one or more frames of the audio signal based on one or more first conditions; a first background noise estimation module configured to estimate a first background noise estimation if voice activity is not detected based on the one or more first conditions; a second voice activity detection module configured to detect voice activity in the one or more frames of the audio signal based on one or more second conditions, whereby voice activity is detected in the one or more frames more often based on the one or more second conditions than based on the one or more first conditions; and a second background noise estimation module configured to estimate a second background noise estimation based if voice activity is not detected based on the one or more second conditions and update the second background noise estimate based on the first background noise estimate; wherein the first background noise estimation module is configured to estimate the first background noise estimate based on background noise information received during one or more discontinuous transmission frames.

In accordance with an embodiment there is an apparatus comprising: first means for detecting voice activity in one or more frames of the audio signal based on one or more first conditions; first means for estimating a first background noise estimation if voice activity is not detected based on the one or more first conditions; second means for detecting voice activity in the one or more frames of the audio signal based on one or more second conditions; and second means for estimating a second background noise estimation if voice activity is not detected based on the one or more second conditions; wherein the voice activity is detected in the one or more frames less often based on the one or more first conditions than based on the one or more second conditions.

In accordance with an embodiment there is an apparatus comprising: first means for estimating a first background noise estimate based on background noise information received during one or more discontinuous transmission frames; second means for estimating a second background noise estimate of the audio speech signal in one or more frames; wherein the second means for estimating updates the second background noise estimate based on the first background noise estimate.

In accordance with an embodiment there is an apparatus comprising: first means for detecting voice activity in one or more frames of the audio signal based on one or more first conditions; first means for estimating a first background noise estimation if voice activity is not detected based on the one or more first conditions; second means for detecting voice activity in the one or more frames of the audio signal based on one or more second conditions, whereby voice activity is detected in the one or more frames more often based on the one or more second conditions than based on the one or more first conditions; and second means for estimating a second background noise estimation if voice activity is not detected based on the one or more second conditions and update the second background noise estimate based on the first background noise estimate; wherein first means for estimating estimates the first background noise estimate based on background noise information received during one or more discontinuous transmission frames.

In accordance with an embodiment there is an apparatus comprising: at least one processor and at least one memory including computer code, the at least one memory and the computer code configured to with the at least one processor cause the apparatus to at least: detect voice activity in one or more frames of the audio signal based on one or more first conditions; estimate a first background noise estimation if voice activity is not detected based on the one or more first conditions; detect voice activity in the one or more frames of the audio signal based on one or more second conditions; and estimate a second background noise estimation based if voice activity is not detected based on the one or more second conditions; wherein the voice activity is detected in the one or more frames less often based on the one or more first conditions than based on the one or more second conditions.

In accordance with an embodiment there is an apparatus comprising: at least one processor and at least one memory including computer code, the at least one memory and the computer code configured to with the at least one processor cause the apparatus to at least: estimate a first background noise estimate based on background noise information received during one or more discontinuous transmission frames; estimate a second background noise estimate of the audio speech signal in one or more frames; and update the second background noise estimate based on the first background noise estimate.

In accordance with an embodiment there is an apparatus comprising: at least one processor and at least one memory including computer code, the at least one memory and the computer code configured to with the at least one processor cause the apparatus to at least: detect voice activity in one or more frames of the audio signal based on one or more first conditions; estimate a first background noise estimation if voice activity is not detected based on the one or more first conditions; detect voice activity in the one or more frames of the audio signal based on one or more second conditions, whereby voice activity is detected in the one or more frames more often based on the one or more second conditions than based on the one or more first conditions; and estimate a second background noise estimation based if voice activity is not detected based on the one or more second conditions and update the second background noise estimate based on the first background noise estimate; wherein the first background noise estimate is based on background noise information received during one or more discontinuous transmission frames.

Various other aspects and further embodiments are also described in the following detailed description and in the attached claims.

### BRIEF DESCRIPTION OF THE DRAWINGS

For a better understanding of the present application and as to how the same may be carried into effect, reference will now be made by way of example to the accompanying drawings in which:

FIG. 1 illustrates a schematic block diagram of an apparatus according to some embodiments;

FIG. 2 illustrates a schematic block diagram of a portion of the electronic device according to some more detailed embodiments;

FIG. 3 illustrates a flow diagram of a method according to some embodiments;

FIG. 4 illustrates a flow diagram of a method according to some other embodiments; and

FIG. 5 illustrates a flow diagram of a method according to some other embodiments.

### DETAILED DESCRIPTION

The following describes apparatus and methods for processing an audio speech signal and estimating background noise in an audio speech signal.

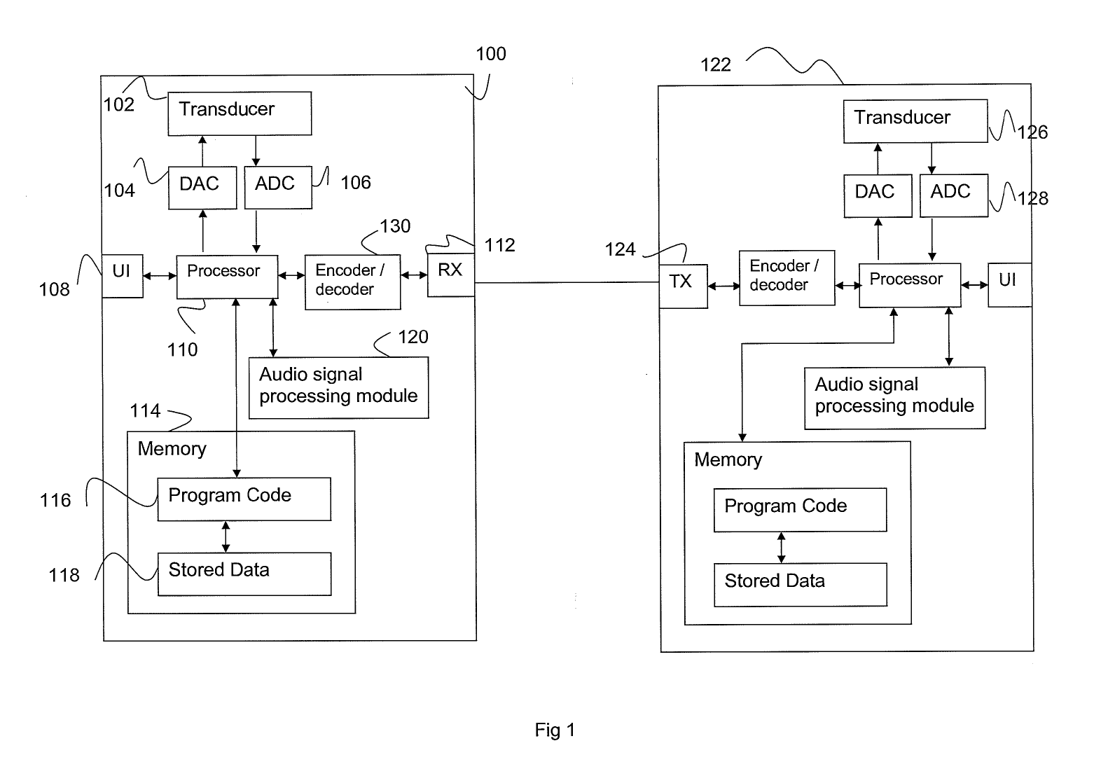

In this regard reference is made to FIG. 1 which discloses a schematic block diagram of an example electronic device 100 or apparatus suitable for employing embodiments of the application. The electronic device 100 is configured to suppress noise of an audio speech signal.

The electronic device 100 is in some embodiments a mobile terminal, a mobile phone or user equipment for operation in a wireless communication system. In other embodiments, the electronic device is a personal computer, a laptop, a smartphone, personal digital assistant (PDA), or any other electronic device suitable for audio communication with another device.

The electronic device 100 comprises a transducer 102 connected to a digital to analogue converter (DAC) 104 and an analogue to digital converter (ADC) 106 which are linked to a processor 110. The processor 110 is linked to a receiver (RX) 112 via an encoder/decoder module 130, to a user interface (UI) 108 and to memory 114. The electronic device 100 receives a signal via the receiver 112 from another electronic device 122 via a transmitter 124.

The digital to analogue converter (DAC) 104 and the analogue to digital converter (ADC) 106 may be any suitable converters. The DAC 104 can send an electronic audio signal output to the transducer 102 and on receiving the audio signal from the DAC 104, the transducer 102 can generate acoustic waves. The transducer 102 can also detect acoustic waves and generate a signal. In some embodiments the transducer can be a separate microphone and speaker arrangement connected respectively to the ADC 106 and the DAC 104.

The processor 110 in some embodiments can be configured to execute various program codes. For example, the implemented program code can comprise a code for audio signal processing or configuration. The implemented program codes in some embodiments further comprise additional code for estimating background noise of audio speech signals. The implemented program codes can in some embodiments be stored, for example, in the memory 114 and specifically in a program code section 116 of the memory 114 for retrieval by the processor 110 whenever needed. The memory 114 in some embodiments can further provide a section 118 for storing data, for example, data that has been processed in accordance with the application.

The receiving electronic device 100 can comprise an audio signal processing module 120 or any suitable means for processing an audio signal. The audio signal processing module 120 can be connected to the processor 110. In some embodiments the audio signal processing module 120 can be replaced with the processor 110 which can carry out the audio signal processing operations. The audio signal processing module 120 in some embodiments can be an application specific integrated circuit.

Alternatively or additionally the audio signal processing module 120 can be integrated with the electronic device 100. In other embodiments the audio signal processing module 120 can be separate from the electronic device 100. This means the processor 110 in some embodiments can receive a modified signal from an external device comprising the audio signal processing module 120, if required.

In some embodiments the receiving electronic device 100 is a receiving mobile terminal 100 and is in communication with transmitting mobile terminal 122, which can also be identical to the electronic device described with reference to FIG. 1. Both mobile terminals can transmit and receive audio speech signals, but for the purposes of clarity the mobile terminal 100 as shown in FIG. 1 is receiving an audio signal transmitted from the other terminal 122.

A user can speak at the transmitting mobile terminal 122 into the transducer 126 and the ADC 128 can generate a digital signal which is processed and encoded for sending to the receiving mobile terminal 100. The audio speech signal can be sent to the mobile terminal 100 over a plurality of frames, each of which comprises audio information. Some of the frames are “speech frames” and comprise information relating to the audio speech signal. Other frames may not comprise the audio speech signal but still comprise an audio signal such as background noise.

Discontinuous transmission (DTX) can be applied to the audio signal depending on whether speech is determined to be present in the audio signal. When discontinuous transmission is applied to an audio signal, speech encoding by the transmitting terminal and speech decoding by the receiving mobile terminal 100 are stopped. Discontinuous transmission (DTX) can be applied to frames which only comprise background noise and this means that less data associated with the background noise is sent over radio resources. Furthermore the mobile terminals also consume less power during discontinuous transmission. In some embodiments, the receiving mobile terminal receives an indication that the discontinuous transmission is in operation. However, the speech enhancement module 210 may not receive the indication whether DTX is active. For example, the decoder module 204 and speech enhancement module 210 can be located in different processors of the mobile terminal 100 and the indication that DTX is being used may not necessarily be sent to the speech enhancement module 210.

Complete silence during a conversation has been found to be unpleasant for the user and in order to provide a more pleasant experience for the user, an approximation of background noise can be generated by the receiving mobile terminal 100 based on parameters estimated in the transmitting mobile terminal 122. The approximation of the background noise generated by the receiving mobile terminal 100 is also known as “comfort” background noise. However the parameters which are used for comfort background noise generation only represent an approximate spectrum of the actual background noise incident at the transmitting mobile terminal. This means that the estimation of the background noise based on the parameters can lack some noise components such as periodic noise components.

When discontinuous transmission is active, the processor 110 can send a comfort background noise signal based on the received parameters to the DAC 104. The DAC 104 can then send a signal to the transducer 102 which generates acoustic waves corresponding to the determined comfort background noise. In this way the user of the receiving mobile terminal 100 can hear the comfort background noise when no speech is present.

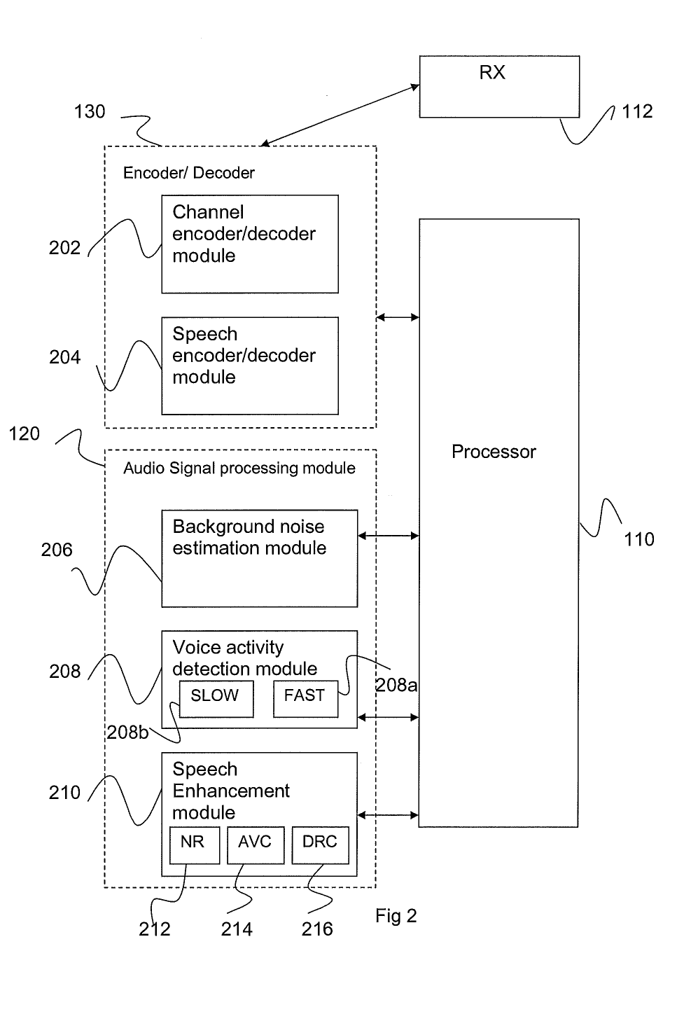

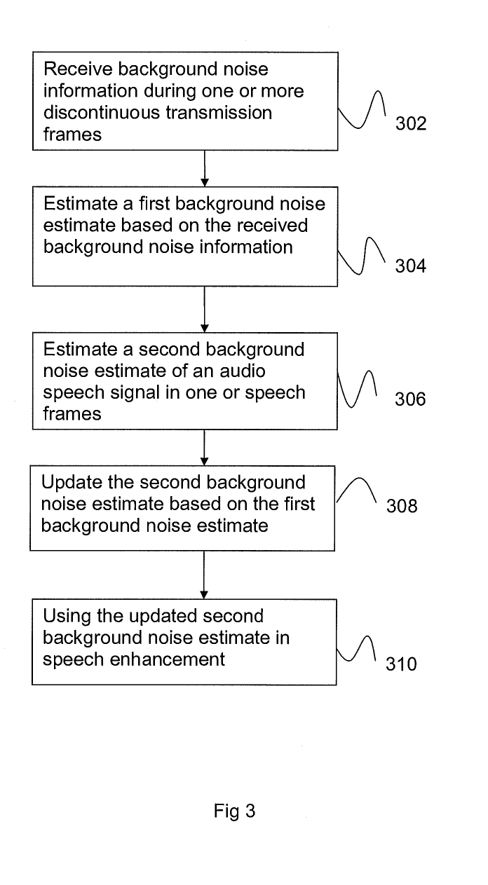

Embodiments will now be described which use the comfort background noise signal for updating a background noise estimate used for VAD and speech enhancement. The background noise estimate is updated when DTX is operative so that the VAD process at the receiving mobile terminal 100 can use the estimate when speech next resumes. Suitable apparatus and possible mechanisms for updating the estimating background noise will now be described in further detail with reference to FIGS. 2 and 3. FIG. 2 illustrates a schematic block diagram of a portion of the electronic device according to some more detailed embodiments. FIG. 3 illustrates a flow diagram of a method according to some embodiments.

The receiving mobile terminal 100 is shown in more detail in FIG. 2. The receiving mobile terminal 100 can comprise an encoder/decoder 130 which comprises channel encoder/decoder module 202 for decoding the transmitted frames and a speech encoder/decoder module 204 for decoding the encoded speech signal. The encoder/decoder 130 receives the frames from the transmitting mobile terminal 122 and sends the decoded frames to the processor 110. In some embodiments any suitable means can be used for decoding the channel frame and the encoded speech.

The receiving mobile terminal 100 also comprises a background noise estimation module 206 for estimating the background noise in an audio signal and a voice activity detection module 208 for detecting whether speech is present in an audio signal and a speech enhancement module 210. The speech enhancement module 210 can comprise different sub-modules for performing different speech enhancement algorithms. In particular the speech enhancement module 210 can comprise a noise reduction (NR) module 212, an automatic volume control (AVC) module 214, and a dynamic range control (DRC) 216 module.

In some embodiments the audio signal processing module 120 can comprise additional modules for further signal processing of the audio signal. Alternatively, in some embodiments the audio signal processing module 120 is not present and each module of the audio signal processing module can be a separate and distinct entity which the processor 110 can send and receive information to. In other embodiments, the processor 110 can replace the audio signal processing module 120 and can perform all the operations of the audio signal processing module 120. Indeed additionally or alternatively the processor 110 can perform the operations of any of the modules.

In some embodiments when DTX is active, the receiving mobile terminal 100 receives one or more frames comprising background noise information via the receiver 112 as shown in block 302. In other embodiments any suitable means can be used to receive the estimated parameters. The background noise information can comprise the estimated parameters describing the background noise from the transmitting mobile terminal 122 for generating a comfort background noise. The estimated parameters can be received periodically from the transmitting mobile terminal. The transmitting mobile terminal can send the estimated parameters of the background noise less frequently than when the speech frames are transmitted. Sending the estimated parameters of the background noise less frequently can save bandwidth of radio resources of a communications network.

The receiver 112 sends the data frames comprising the background noise information to the encoder/decoder 130. The encoder/decoder 130 sends the decoded frames comprising the received estimated parameters to the processor 110.

The encoder/decoder 130 generates the first background noise estimate based on the received background noise information as shown in block 304. The encoder/decoder 130 sends the first background noise estimate to the processor 110 which sends the first background noise estimate to the audio signal processing module 120. The first background noise estimate is updated in the comfort noise frames and in such speech frames that the VAD 208 considers as noise. In some embodiments any suitable means can be used to generate the background noise on the basis of the received background information.

When DTX is active, the processor 110 determines that the transmitting mobile terminal 122 has determined that the frames comprise noise. The processor 110 can send an indication to the audio signal processing module 120 that the DTX is active. The voice activity detection module 208 can determine that the received frames comprise noise from the indication and the audio signal processing module 120 can sends a signal to the speech enhancement module 210 to suspend some processes therein. The speech enhancement module 210 can switch to a comfort noise mode. In this way, the speech enhancement module may not enhance speech, but, for example, noise reduction can be kept at the same level as speech frames.

At some point later, the processor 110 may determine that DTX is inactive. For example, the processor 110 can receive the decoded frames from the encoder/decoder 130 and can determine that frames contain speech from an indication in the frames. The processor 110 sends the speech frames to the audio signal processing module 120. The background noise estimation module 206 then estimates a second background noise estimate in an audio speech signal in one or more frames as shown in block 306. In some embodiments any suitable means can be used to estimate the second background noise estimate in an audio speech signal in one or more frames.

The voice activity detection module 208 uses the background noise estimates to determine whether speech is present in frames and speech and noise level estimates are updated according to the output of the voice activity detection module 208. In order to prevent false speech detections, the voice activity detection module 208 determines whether speech is present in frames based on a plurality of background noise estimates in frames without speech.

When DTX is inactive the background noise estimation module can determine the background noise estimate in frames without speech from “false speech frames”. That is frames which have been indicated by the transmitting mobile terminal 122 as comprising speech frames, but the voice activity detection module actually determines there is no speech present. This means that the background noise estimation module 206 can estimate the background noise estimate of frames without speech from false speech frames.

However, if the frames indicate that DTX is active the voice activity detection module 208 sends a signal to initiates suspending some processes carried out by the speech enhancement module 210, such as halting noise estimation. When speech resumes and DTX becomes inactive after a pause in speech any background noise estimate based on false speech frames can be old and possibly unrepresentative of the actual background noise at the transmitting mobile terminal 122.

Embodiments can use the parameters for generating the comfort background noise when DTX is active as a basis for estimating the background noise in frames without speech. In this way the background noise estimation module 206 updates the second background noise estimate based on the first background noise estimate as shown in block 308. In some embodiments any suitable means can be used to update the second noise estimate. The background noise estimation module 206 updates the second background noise estimate with the comfort background noise approximation. Since first background noise estimate is based on estimated parameters of background noise during the DTX active period, the first background noise estimate, based on the received noise parameters for generating the comfort noise, can be a better estimate of background noise in frames without speech.

The updated second background noise estimate is then used by the speech enhancement module 210 for improving the quality of the speech signal as shown in block 310. The updated second background noise estimate can be used in voice activity detection module 208, the noise reduction module 212, the automatic volume control module 214 and/or the dynamic range control module 216.

In some embodiments the second background noise estimate can be used for VAD and noise reduction. Alternatively or additionally, the VAD can be used for AVC and DRC.

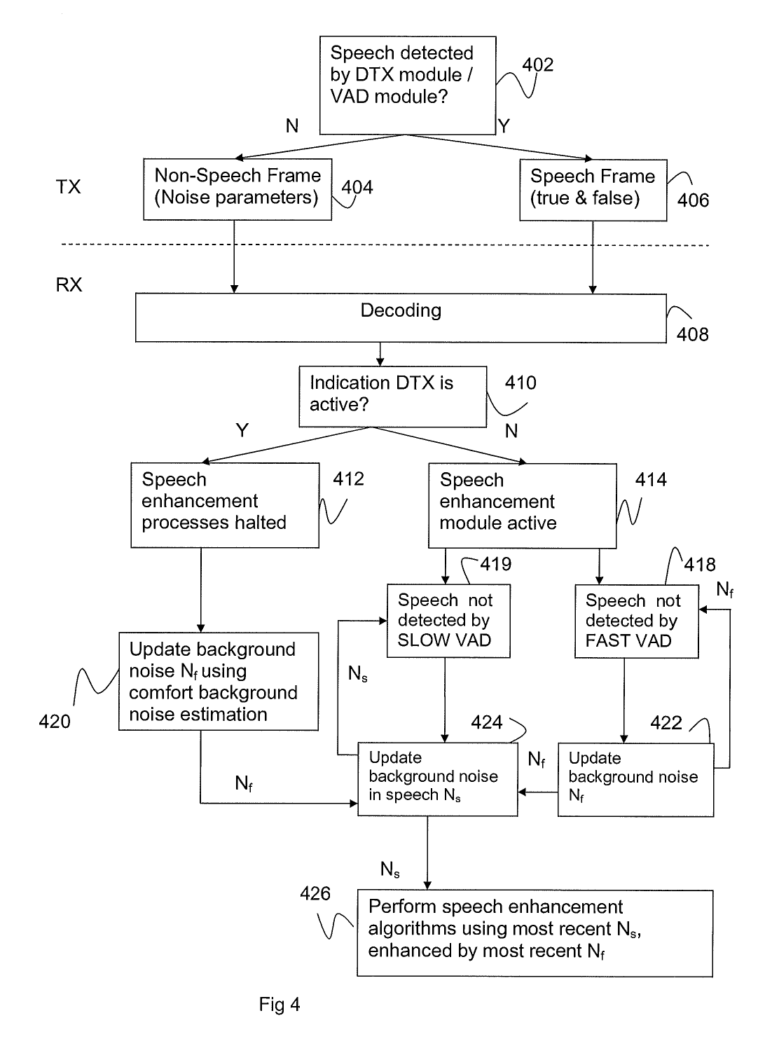

More detailed embodiments will now be described in reference to FIG. 4. FIG. 4 discloses a schematic flow diagram of a method according to some embodiments. FIG. 4 illustrates a method which is implemented at both the transmitting mobile terminal 122 and the receiving mobile terminal 100. The dotted line and the labels “TX” and “RX” shows the where the different parts of the method are carried out.

In some embodiments the transmitting mobile terminal 122 comprises a DTX module (not shown) which determines whether the DTX should be active or inactive. The determination is made by a VAD module at the transmitting mobile terminal 122 (not shown) which can be part of the DTX module. The VAD module of the transmitting mobile terminal 122 determines whether speech is present in an audio signal based on the characteristics of the audio signal as shown in block 402.

If the VAD module of the transmitting mobile terminal 122 determines that the frames comprise speech, then the DTX module remains in an inactive state and indicates that the frames are speech frames as shown in block 406. The frames indicated as speech frames by the DTX module can be “true speech frames” or “false speech frames”. True speech frames are frames that do comprise a speech signal whereas false speech frames are frames that are marked as speech frames but do not comprise a speech signal. The DTX module generates indications that a frame is a speech frame, which may later in signal processing be considered as containing noise, so that no speech frames are lost, for example, by indicating a speech frame as a non-speech frame.

If the VAD module of the transmitting mobile terminal 122 determines that the frames do not comprise speech frames, the DTX module activates the DTX operation. During DTX operation the transmitting mobile terminal 122 does not send the speech frames to the receiving mobile terminal 100. Instead the transmitting mobile terminal 122 sends non-speech frames which comprise estimated parameters of the background noise during the period of discontinuous transmission as shown in block 404.

The estimated parameters of the background noise at the transmitting mobile terminal 122 can be used for generating the comfort background noise, and this comfort background noise can be used, in one part, for generating the first background noise estimate N_{f}. The first background noise estimate N_{f} is an auxiliary estimate of the background noise in a speech frame when no speech signal is present or when DTX is active.

The encoder/decoder 130 of the receiving mobile terminal 100 receives the frames from the transmitting mobile terminal 122 via the receiver 112. If DTX is active, the encoder/decoder 130 decodes the non-speech frames as shown in block 408 and sends the decoded non-speech frames to the processor 110. The processor 110 then determines whether DTX operation is active from the data in the decoded frame as shown in step 410. The processor 110 can determine that the DTX is active from an indication comprised in the non-speech frames. If the processor 110 determines that DTX is active, the processor sends an indication that DTX is active to the audio signal processing module 120. The audio signal processing module 120 initiates stopping some processes of the speech enhancement module 210 such as dynamic range control etc since the frames do not contain speech as shown in step 412. However, in some embodiments the speech enhancement module 120 applies, for example, noise reduction when DTX is active.

In some embodiments the comfort background noise is generated by the speech decoder parts of the encoder/decoder 130. The generated comfort background noise is used by the background noise estimation module 206. This allows for one background noise estimation module in the audio signal processing module 120. The processor 110 sends the generated comfort background noise to the background noise estimation module 206 in the audio signal processing module 120. The background noise estimation module 206 then generates the first background noise estimate N_{f} based on the comfort background noise generated using the received estimated parameters as shown in block 420. In other embodiments the comfort background noise is generated by another module (not shown) that is capable of interpreting the received estimated parameters of the actual environmental background noise.

In this way, during the DTX operation, the first background noise estimate N_{f} is determined based on the comfort background noise generated using the received estimated background noise parameters. This means that the noise estimate generated by the background noise estimation module follows changes in the background noise level during longer speech pauses when DTX is active.

The first background noise estimate N_{f} based on the comfort background noise approximation can then be used by the background noise estimation module 206 to update the second background noise estimate Nₛ when DTX next becomes inactive, as represented by the arrow from block 420 to block 424.

At some other time, the encoder/decoder 130 can decode received frames when the DTX is inactive. The processor 110 can determine from the decoded frames that DTX is inactive as shown in block 410. The processor can determine that the DTX is inactive from an indication comprised in the speech frames. The processor 110 can send an indication to the audio signal processing module 120 that the frames comprise speech and that the speech enhancement module 210 should be activated as shown in block 414. The processor 110 can send the decoded speech frames to the voice activity detection module 208 of the audio signal processing module 120 to determine whether the indicated speech frames are false speech frames or true speech frames as shown in block 418.

In some embodiments the audio signal processing module 120 can comprise two VAD modules 208a, 208b. The two VAD modules 208a, 208b comprise a first VAD module 208a associated with the first background noise estimate N_{f} and a second VAD module 208b associated with the second background noise estimate Nₛ. The first VAD module 208a is configured to determine false speech frame more often. In this way N_{f} is updated faster because the noise estimation is performed more often and the first VAD module 208a is called “fast VAD”. That is, the first VAD module 208a updates a noise estimate more frequently than the second VAD module 208b. Likewise the second VAD module 208b updates the noise estimation less often than the first VAD module 208a and is called “slow VAD”. In some embodiments the two VAD modules 208a, 208b can be separate modules, alternatively the processes of the two VAD modules can be performed by a single module. In some embodiments the first background noise estimate N_{f} and the second background noise estimate Nₛ can be determined in the frequency domain.

In some embodiments, both the VAD modules 208a and 208b determine whether speech is not present in decoded frames based on one or more characteristics of the audio signal in the frames as shown in blocks 419 and 418. In some embodiments the first and second VAD modules 208a, 208b can respectively use previously determined first and second background noise estimations N_{f} and Nₛ. In some embodiments the VAD modules 208a and 208b compare the spectral distance to a noise estimate, determines the periodicity of the audio signal and the spectral shape of the signal to determine whether the speech is present in the frames. The first and second VAD modules 208a, 208b are configured to determine noise in frames based on different thresholds and/or different parameters. The VAD modules 208a and 208b also obtain previous estimates of the first background noise estimate N_{f} and/or a second background noise estimate Nₛ.

In some embodiments the voice activity detection can be determined based on a direction characteristic of the audio signal. In some circumstances the sound can be captured from a plurality of microphones which can enable a determination of a direction which the sound originated from. The voice activity detection modules 208a, 208b can determine whether a frame comprises speech based on the direction characteristic of the sound signal. For example, background noise may be ambient and may have not a perceived direction of origin. In contrast speech can be determined to originate from particular direction, such as the mouth of a user.

In some embodiments both the first background noise estimate N_{f} and the second background noise estimates Nₛ are updated during frames that are determined not to contain speech as shown in blocks 424 and 422.

However the first VAD module 208a associated with the first background noise estimate N_{f} determines that less of the frames contain speech. In this way the first background noise estimate N_{f} is updated more frequently. Conversely the second background noise estimate Nₛ is updated less frequently because the second VAD module 208b determines more of the frames contain speech. As such the first VAD module 208a is a fast VAD module and the second VAD module 208b is a slow VAD module. Since the first background noise estimate is updated more frequently N_{f} can follow changes in the background noise more quickly but with a risk of some partial speech elements being incorrectly determined as noise. The second VAD module 208b prevents the second background noise estimate Nₛ comprising any partial speech elements but this means the second background noise estimate can be less sensitive in following changes in the noise.

In some embodiments, the second background noise estimate Nₛ can be based on the first background noise estimate N_{f} to provide a more robust noise estimate as shown by the arrow from block 422 to 424. As mentioned, the first background noise estimate N_{f} is based on estimate noise in a frame without speech. The first background noise estimate N_{f} follows changes in background noise robustly and can change rapidly. The second background noise estimate Nₛ is also based on background noise in a frame without speech but using different criteria. The second background noise estimate Nₛ changes slower than the first background noise estimate N_{f} because the first VAD module 208a determines that frames contain speech more often. Since the first background noise estimate N_{f} changes rapidly, it is less suitable for speech enhancement algorithms and so Nₛ is used. However, to ensure that Nₛ reflects changes to the background noise and can limit false speech detections, Nₛ is controlled by N_{f}.

In some embodiments Nₛ can be controlled by N_{f} by replacing Nₛ with a combination of Nₛ and N_{f}. In some embodiments Nₛ can be replaced with an average of Nₛ and N_{f}. In other embodiments Nₛ can be replaced with a weighted mean of Nₛ and N_{f}, whereby either N_{f} or Nₛ have a greater weighting than Nₛ or N_{f} respectively.

In some embodiments the background estimation module 206 can be used to control the second background noise estimate Nₛ with the first background noise estimate N_{f}. The background noise estimation module 206 can optionally comprise a counter module which determines the period of time that the first background noise estimate N_{f} stays within a range. When the counter determines that the first background noise estimate has stayed or remained within a particular range for a determined period of time, the value Nₛ is replaced with the mean average of Nₛ and N_{f}. In some embodiments the bandwise maxima of Nₛ and N_{f} is substituted for the main estimate Nₛ, where the bandwise maxima is the maximum of Nₛ(w), N_{f}(w) for each frequency band w. This ensures that periodic noise components are preserved in the noise estimate used in noise suppression gain calculation and periodic noise components are attenuated when the speech frames next start. That is, periodic noise components are removed from a speech signal via noise suppression. To achieve this, the periodic components in the noise estimate when DTX is not active are preserved by using the bandwise maxima. This means that the periodic components in the noise estimate are not removed completely by updating the second background noise estimate Nₛ directly with the first background noise estimate N_{f} based on the comfort noise approximation. Periodic noise components are not reflected in the comfort noise because the noise in the transmitting end is estimated with a low number of parameters for DTX to save bandwidth in the air interface and the comfort noise is produced by generating random noise and shaping it to an approximate spectral envelope of the actual background noise using the received estimated parameters. In this way the use of bandwise maximum values is used for maintaining the periodic components of the actual background noise in the main noise estimate Ns.

In some embodiments the counter can count the number of frames that the second noise estimate N_{f} stays below a particular threshold level of a signal. The counter can be incremented only in frames where the signal level is also below a determined long term speech level.

When the DTX is active the fast VAD module 208a uses the comfort background noise generated using the received estimated noise parameters to estimate the first background noise estimate N_{f}. This provides a better reflection of the background environmental noise incident at the transmitting mobile terminal 122. This means that when the receiving mobile terminal 100 next receives speech frames, the comfort background noise can be used in a noise reduction solution to provide a sufficient attenuation of the background noise in the frames containing speech. Furthermore since the estimated parameters for generating the comfort background noise are updated during long pauses when DTX is active, the first background noise estimate N_{f} will follow changes in the background noise better than if the background noise estimation were halted when DTX is active. This means that noise pumping where the background noise level changes rapidly can be avoided.

In some embodiments the first and second noise estimates N_{f} and Nₛ are sent to the first and second VAD modules 208a and 208b for future VAD processing. In this way the first and second VAD modules 208a, 208b can determine whether speech is present in a frame using the most recent noise estimates N_{f}, Nₛ.

The speech enhancement module 210 then performs the speech enhancement algorithms based on the second background noise estimate Nₛ as shown in block 426. The second background noise estimate Nₛ is based on the most recent first background noise estimate N_{f}. In some embodiments the speech enhancement module 210 uses the second background noise estimate Nₛ with noise reduction, automatic volume control and/or dynamic range control.

This means that the first background noise estimate N_{f} is updated during DTX active state and during DTX inactive state when frames are “false speech frames”. The first background noise estimate N_{f} is determined using the fast VAD module 208a. Furthermore the second background noise estimate Nₛ is updated only during DTX inactive state where frames are “false speech frames”. The second background noise estimate Nₛ is determined using the slow VAD module 208b. Once Nₛ has been determined, N_{f} is used to enhance Nₛ.

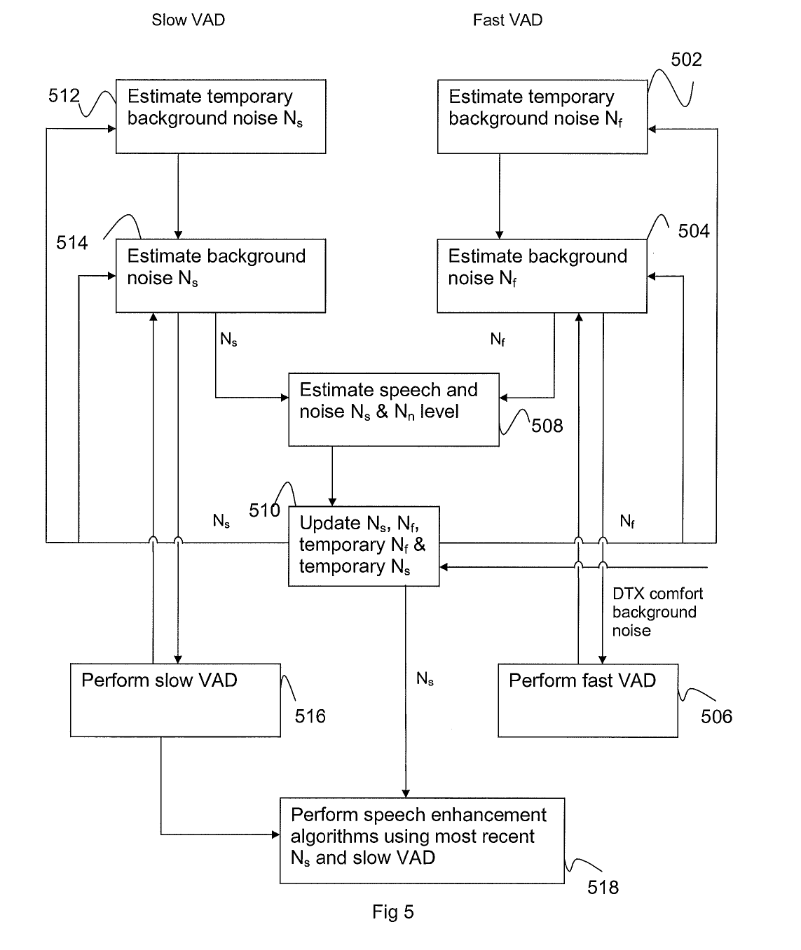

Some other embodiments will now be described in reference to FIG. 5. FIG. 5 illustrates a flow diagram of FIG. 4 illustrating in more detail the VAD and noise estimation processes.

In some embodiments the processor 110 initiates the audio signal processing module 120 to perform a slow voice activity detection by the second VAD module 208b and a fast voice activity detection by the first VAD module 208a on frames which have been determined to be speech frames by a DTX module in the transmitting mobile terminal 122. In some embodiments the first VAD module 208a and the second VAD module 208b determine whether the frames contain speech at the same time.

As mentioned in reference to FIG. 4 the fast VAD process is used to determine the first background noise estimation N_{f} and the slow VAD process is used to determined the second background noise estimation Nₛ. The fast VAD process is used for determining N_{f} to allow that the first background noise estimate N_{f} can change rapidly. The slow VAD process is used for determining Nₛ to make the second background noise estimate Nₛ change more slowly. The first background noise estimation N_{f} can be used to control the determination of the second background noise estimation Nₛ.

If the VAD modules 208a 208b determine that the indicated speech frames do not contain speech, the VAD modules 208a and 208b carry out the fast and slow VAD process to estimate N_{f} and Nₛ in parallel. Optionally a temporary first background noise estimate is made as shown in block 502. The processor 110 instructs the background noise estimation module 206 of the audio signal processing module 120 to determine the temporary first background noise estimate. The temporary first background noise estimate is made to avoid updating the beginning of speech activity.

Once the temporary first background noise estimation has be generated, and the first VAD module 208a has determined speech activity is not present in a frame, the first background noise estimation N_{f} is determined as shown in block 504. The background noise estimate is determined similar to the process described with reference to block 304 of FIG. 3.

The first background noise estimate N_{f} is then sent to the first VAD module 208a to carry out the fast VAD operation as shown in block 506. The fast voice activity detection can react rapidly to changes in the background noise level. In some embodiments the fast VAD can be based on the spectral distance of the speech signal spectrum and the noise spectrum. Additionally or alternatively the fast VAD can be based on autocorrelation or periodicity/pitch, signal level determination and spectral shape of input signal spectrum. This means that the first background noise estimate reacts faster for changes in actual background noise level, which can be used to control the second background noise estimation Nₛ. The output of the fast VAD module 208a can be sent to the background estimation module 206.

The first background noise estimate N_{f} and the second background noise estimate Nₛ can be used to estimate the noise level as shown in block 508. Noise level estimates are computed directly from Nₛ and N_{f}. Furthermore, a speech level estimate can be determined based on a signal level and an output from both the first and second VAD modules 208a, 208b (fast and slow VAD processes). The estimated speech and noise levels can then used by the processor 110 to update the first and second background noise estimates N_{f} and Nₛ as shown in block 510. The estimated speech and noise levels can also be used in voice activity detection and speech enhancements (noise reduction, automatic volume control, and dynamic range control). The updated first background noise estimation N_{f} can be sent to the background noise estimation module 206 for estimating the first background noise estimate N_{f} again. In this way subsequent first background noise estimates are based on previous first background noise estimates N_{f}. The first and second background noise estimates N_{f}, Nₛ are also updated in block 510. The updated values of N_{f}, Nₛ are then used in blocks 504 and 514 in the next iteration. Similarly the temporary estimates are updated in blocks 512 and 502 similarly.

If the audio signal processing module 120 has just been activated the processor 110 can determines that the most recent first background noise estimate N_{f} will be based on estimated noise parameters received during a recent DTX active period. In this way, the comfort background noise approximation generated using the received estimated noise parameters can be used for the first background noise estimate N_{f} and for controlling the second background noise estimate Nₛ.

At the same time, if the second VAD module 208b determines that the indicated speech frames do not contain speech, the second VAD module 208b can carry out a slow VAD process to estimate Nₛ.

Optionally, the processor 110 instructs the background noise estimation module 206 to generate a temporary second background noise estimate as shown in block 512, which is similar to block 502. Optionally the processor 110 may obtain a previously estimated temporary background noise made for the fast VAD process. Likewise during the fast VAD process, the processor 110 may optionally obtain a previously estimated temporary background noise made during the slow VAD process.

The background noise estimation module 206 then estimates the second background noise estimate Nₛ as shown in block 514, which is similar to block 306. Similarly subsequent second background noise estimates Nₛ can be generated based on previous second background noise estimates using blocks 508 and 510 as discussed before. Optionally, the second background noise estimate Nₛ can also be based on a first background noise estimate N_{f} made during the VAD fast operation. Likewise during the fast VAD process, the processor 110 may obtain a previously estimated background noise made during the slow VAD process.

The first background noise estimation N_{f} based on the comfort background noise approximation can be sent to the second VAD module 208a to perform a slow VAD as shown in block 516. In some embodiments the slow VAD can be based on the spectral distance of the estimated comfort background noise spectrum from the speech signal spectrum.

Once the speech and noise levels have been estimated, the second VAD module 208b can send an output to the speech enhancement module 210. The output of the slow VAD module 208b can be sent to the background estimation module 206. At the same time an updated second background noise estimate can be sent to the speech enhancement module 210. The speech enhancement mobile 210 can then perform speech enhancement algorithms using the most recent second background noise estimate and an output of the slow VAD module 208b as shown in block 518.

Various modifications and adaptations to the foregoing exemplary embodiments may become apparent to those skilled in the relevant arts in view of the foregoing description, when read in conjunction with the accompanying drawings. However, any and all modifications will still fall within the scope of the non-limiting and exemplary embodiments.

Furthermore, some of the features of the various non-limiting and exemplary embodiments may be used to advantage without the corresponding use of other features. As such, the foregoing description should be considered as merely illustrative of the principles, teachings and exemplary embodiments, and not in limitation thereof.

The electronic device in the preceding embodiments can comprise a processor and a storage medium, which may be electrically connected to one another by a databus. The electronic device may be a portable electronic device, such as a portable telecommunications device.

The storage medium is configured to store computer code required to operate the apparatus. The storage medium may also be configured to store the audio and/or visual content. The storage medium may be a temporary storage medium such as a volatile random access memory, or a permanent storage medium such as a hard disk drive, a flash memory, or a non-volatile random access memory. The processor is configured for general operation of the electronic device by providing signaling to, and receiving signaling from, the other device components to manage their operation.

In some embodiments the controller can be configured by or be a computer program or code operating on a processor and optionally stored in a memory connected to the processor. The computer program or code can in some embodiments arrive at the audio signal processing module via any suitable delivery mechanism. The delivery mechanism may be, for example, a computer-readable storage medium, a computer program product, a memory device such as a flash memory, a portable device such as a mobile phone, a record medium such as a CD-ROM or DVD, an article of manufacture that tangibly embodies the computer program. The delivery mechanism may be a signal configured to reliably transfer the computer program. The system may propagate or transmit the computer program as a computer data signal to other external devices such as other external speaker systems. Although the memory is mentioned as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific integration circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device.

Although embodiments of the present application have been described in the preceding paragraphs with reference to various examples, it should be appreciated that modifications to the examples given can be made without departing from the scope as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the application believed to be of particular importance it should be understood that the Applicant claims protection in respect of any patentable feature or combination of features hereinbefore referred to and/or shown in the drawings whether or not particular emphasis has been placed thereon.

Furthermore it should be realised that the foregoing embodiments should not be constructed as limiting. Other variations and modifications will be apparent to person skilled in the art upon reading the present application. The disclosure of the present application should be understood to include any novel features or any novel combination of features either explicitly or implicitly disclosed herein or any generalisation thereof and during the prosecution of the present application or of any application derived there from, new claims may be formulated to cover any such features and/or combination of such features.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

There is a further embodiment comprising a combination of one or more of any of the other embodiments previously discussed.

1-61. (canceled)

62. An apparatus comprising:
a first voice activity detection module configured to detect a first voice activity in one or more frames of an audio signal;
a first background noise estimation module configured to estimate a first background noise estimation if the first voice activity is not detected;
a second voice activity detection module configured to detect a second voice activity in the one or more frames of the audio signal;
a second background noise estimation module configured to estimate a second background noise estimation if the second voice activity is not detected; and
wherein the first voice activity is detected in the one or more frames less often-than the second voice activity.

63. The apparatus as claimed in claim 62, wherein the second background noise estimation module is configured to update the second background noise estimation based on the first background noise estimation.

64. The apparatus as claimed in claim 62, wherein the second background noise estimation module is configured to update the second background noise estimation with at least one of:
a combination of the first and second background noise estimates; and
a weighted mean of the first and second background noise estimates.

65. The apparatus as claimed in claim 62, wherein the first background noise estimation is updated faster than the second background noise estimation.

66. The apparatus as claimed in claim 62, wherein a voice activity detection module comprises the first voice activity detection module associated with the first background noise estimation and the second voice activity detection module associated with the second background noise estimation.

67. The apparatus as claimed in claim 62, wherein the first voice activity detection module is configured to update the first background noise estimation faster than the second voice activity detection module.

68. The apparatus as claimed in claim 62, wherein a speech enhancement module is configured to use an output of the second voice activity detection module based on the second background noise estimation.

69. The apparatus as claimed in claim 68, wherein the speech enhancement module is configured to perform one or more of noise reduction, automatic volume control, dynamic range control.

70. The apparatus as claimed in claim 62, wherein the first and second voice activities are detected based on one or more characteristics of the audio signal.

71. The apparatus as claimed in claim 70, wherein the one or more characteristics of the audio signal are at least one of the following: a spectral distance of the audio signal, periodicity of the audio signal, a direction of the audio signal, a spectral shape of the audio signal.

72. The apparatus as claimed in claim 62, wherein the second voice activity detection module is configured to detect the second voice activity when a discontinuous transmission mode is inactive.

73. The apparatus as claimed in claim 62, wherein the first background noise estimation module is configured to estimate the first background noise estimation based on at least one of:
background noise information received during one or more discontinuous transmission frames; and
a comfort background noise approximation determined from background noise information received during discontinuous transmission frames.

74. The apparatus as claimed in claim 73, wherein the second background noise estimation module is configured to use the first background noise estimation for estimating the second background noise estimation when discontinuous transmission is inactive.

75. The apparatus as claimed in claim 62, wherein the apparatus is a portable electronic device.

76. A method for estimating background noise of an audio signal comprising:
detecting a first voice activity in one or more frames of the audio signal;
estimating a first background noise estimation if the first voice activity is not detected;
detecting a second voice activity in the one or more frames of the audio signal; and
estimating a second background noise estimation if the second voice activity is not detected;
wherein the first voice activity is detected in the one or more frames less often-first than the second voice activity.

77. The method as claimed in claim 76, wherein the first background noise estimation is based on background noise information received during discontinuous transmission frames.

78. The method as claimed in claim 76, wherein the first background noise estimation is based on a comfort background noise approximation determined from background noise information received during discontinuous transmission frames.

79. The method as claimed in claim 78, wherein the method further comprises using the first background noise estimation based on the comfort background noise approximation for estimating the second background noise estimation when discontinuous transmission is inactive.

80. The method as claimed in claim 76, wherein the first background noise estimation is used for the second background noise estimation after discontinuous transmission becomes inactive.

81. The method as claimed in claim 76, wherein the method comprises updating the second background noise estimation based on the first background noise estimation.
